(19) United States
(12) Patent Application Publication
(10) Pub. No.: US 2003/0022967 A1
(43) Pub. Date: Jan. 30, 2003

(54) Heat-absorbing polymer composition

(76) Inventors: Martin Dobler, Dusseldorf (DE); Wolfgang Ebert, Krefeld (DE)

Correspondence Address: BAYER CORPORATION, PATENT DEPARTMENT, 100 BAYER ROAD, PITTSBURGH, PA, 15205, US

(21) Appl. No.: 10/166,936

(22) Filed: Jun. 11, 2002

(30) Foreign Application Priority Data
Jun. 13, 2001 (DE) 10128704.6

(51) Int. Cl. C08K 5/34; C08K 5/50

(52) U.S. Cl. 524/100; 524/154; 524/105

(57) ABSTRACT

A thermoplastic molding composition suitable for, among others, glazing applications is disclosed. The composition contains a transparent thermoplastic, an organic infrared absorber and a phosphine compound, is characterized by a low tendency to yellowing even after prolonged exposure to thermal stressing, manifested by a small change in its Yellowness Index.

### FIELD OF THE INVENTION

The invention relates to molding compositions and more particularly to heat-absorbing, transparent thermoplastic molding compositions, to their preparation and use in producing useful articles.

### SUMMARY OF THE INVENTION

A thermoplastic molding composition suitable for, among others, glazing applications is disclosed. The composition contains a transparent thermoplastic, an organic infrared absorber and a phosphine compound, is characterized by a low tendency to yellowing even after prolonged exposure to thermal stressing, manifested by a small change in its Yellowness Index.

### BACKGROUND OF THE INVENTION

Glazing made of compositions containing transparent thermoplastic polymers such as, e.g., polycarbonate, offers many advantages for the automotive sector and for buildings in comparison with conventional glazing made of glass, such as, e.g., increased fracture resistance or weight saving. In the case of automotive glazing, greater passenger safety in the event of accidents and a lower fuel consumption due to the weight saving is thereby achieved. Finally, transparent thermoplastic polymers and compositions containing transparent thermoplastic polymers permit substantially greater design freedom due to increased moldability.

However, the considerable heat transmission (i.e., transmission of IR radiation) of transparent thermoplastic polymers when exposed to sunlight leads to undesirable heating of the interior. As described in Parry Moon, Journal of the Franklin Institute 230, pages 583-618 (1940), apart from the visible light range between 400 nm and 750 nm, the near infrared (NIR) range between 650 nm and 1100 nm accounts for the major portion of solar energy. Incoming solar radiation is absorbed, e.g., inside an automobile and emitted as long-wave heat radiation of 5 μm to 15 μm. As conventional glazing materials and particularly transparent thermoplastic polymers are not transparent in this range, the heat radiation cannot be reflected to the outside. A greenhouse effect is obtained. In order to keep the effect as small as possible, the transmission of the glazing in the NIR should be minimized as far as possible. Conventional transparent thermoplastic polymers such as, e.g., polycarbonate, are transparent both in the visible and in the NIR range, however. Additives, for example, which have the lowest possible transparency in the NIR yet the greatest possible transparency in the visible range of the spectrum are, therefore, required.

The literature describes infrared absorbers for this purpose which restrict this heating (e.g., J. Fabian, H. Nakazumi, H. Matsuoka, Chem. Rev. 92, 1197 (1992), U.S. Pat. No. 5,712,332, JP-A 06240146). Organic and inorganic infrared absorbers are known. Organic infrared absorbers are particularly suitable for this purpose. Such dyes have absorption maxima in the near infrared (NIR).

While the use of infrared absorbers in plastic glazing elements leads to an effective reduction in heating in the interior, unwanted heating of the pane itself occurs due to heat absorption. In the event of prolonged solar radiation, very high pane temperatures may be reached, which may have an adverse effect on the material properties of the plastic. This may lead, inter alia, to decomposition of the sensitive infrared absorber with bleaching and/or yellowing of the plastic pane. The main disadvantage in this case is yellowing of the plastic pane which, in the automotive sector, means that safety is appreciably impaired. The Yellowness Index (“Y.l.”) is a measure of the yellowing of plastic panes.

It is also known to add heat stabilizers to thermoplastics during processing to improve stability. Examples of heat stabilizers used to improve processing properties include phosphites, hindered phenols, aromatic, aliphatic or mixed phosphines, lactones, thioethers and hindered amines (HALS).

WO-A 01/18101 discloses molding compounds containing a thermoplastic and a phthalo- or naphthalocyanine dye which may contain antioxidants such as phosphites, hindered phenols, aromatic, aliphatic or mixed phosphines, lactones, thioethers and hindered amines to improve the processing stability.

The object of the invention is to provide heat-absorbing polymer compositions which contain organic infrared absorber and, when used as glazing material, have excellent transparency, good gloss properties and a low yellowing tendency even after prolonged use under the action of solar radiation. More particularly, the glazing elements manufactured from the polymer composition should be characterized by the least possible change in the Yellowness Index (Y.I.), even after prolonged thermal stress.

### DETAILED DESCRIPTION OF THE INVENTION

The object according to the invention is achieved by a polymer composition which contains

(a) a transparent thermoplastic resin

(b) an organic infrared absorber and

(c) a phosphine compound.

The invention also provides a process for the preparation of the composition according to the invention and to the use thereof and to products manufactured therefrom.

Surprisingly, it was ascertained that polymer compositions which, in addition to transparent thermoplastic and organic infrared absorber, also contain a phosphine compound have only a low tendency to yellowing, even after prolonged thermal stress. Glazing elements manufactured from the compositions according to the invention are characterized by a change in the Yellowness Index which is less than 10%, after hot storage at 130° C. for 1000 h. This was surprising because the behavior of other substances known as heat stabilizers such as phosphites, hindered phenols and hindered amines is markedly worse.

Phosphine compounds within the meaning of the invention include all organic derivatives of phosphorus hydride (phosphines) and salts thereof. There are no restrictions regarding the choice of phosphines, and in particular both aliphatic and aromatic and mixed phosphines are suitable for use in the composition according to the invention. The phosphines may be primary, secondary and tertiary phosphines. The use of tertiary phosphines is preferred. Moreover, the use of aromatic phosphines is preferred and the use of tertiary aromatic phosphines is even more preferred. According to a more particularly preferred embodiment of the invention, triphenylphosphine (TPP) or a trinaphthyl phosphine is used. Mixtures of different phosphines may also be used.

The preparation and properties of phosphine compounds are known to the skilled person and described, for example, in EP-A 0 718 354 and “Ullmanns Enzyklopadie der Technischen Chemie”, 4th edition, vol. 18, p. 378-398 and Kirk-Othmer, 3rd edition, vol. 17, p. 527-534.

There are no restrictions regarding the amount of phosphine compounds contained in the composition. The phosphines are used preferably in an amount of 0.0001 wt. % to 10 wt. %, particularly 0.01 wt. % to 0.2 wt. %, based on the weight of the composition.

Organic infrared absorbers which are suitable for use in the composition according to the invention are compounds having the greatest possible absorption between 700 nm and 1500 nm (near infrared=NIR). There should be at least one maximum of absorption, showing a coefficient of absorption of 10³-10⁷M⁻¹cm⁻¹, preferably >10⁴M⁻¹cm⁻¹. Infrared absorbers known from the literature are suitable, e.g., as described by class of substance in M. Matsuoka, Infrared Absorbing Dyes, Plenum Press, New York, 1990. Infrared absorbers from the substance classes comprising phthalocyanines, naphthalocyanines, metal complexes, azo dyes, anthraquinones, squaric acid derivatives, immonium dyes, perylenes, quaterylenes and polymethines are particularly suitable. Of these, phthalocyanines and naphthalocyanines are more particularly suitable. In view of the improved solubility in thermoplastics, phthalocyanines and naphthalocyanines with barrier side groups are preferred, for example phenyl, phenoxy, alkylphenyl, alkylphenoxy, tert.-butyl, -S-phenyl-aryl, -NH-aryl, NH-alkyl and similar groups.

Combinations of organic NIR absorbers and other NIR protective agents may also be used, such as, e.g., inorganic NIR absorbers. In particular, doped metal oxides are suitable for this purpose, such as indium oxide doped with 2 to 30 atom %, preferably with 4 to 12 atom % of tin, or with 10 to 70 atom % of fluorine. Moreover, tin oxide doped with 2 to 60 atom % of antimony or with 10 to 70 atom % of fluorine is particularly suitable. Moreover, zinc oxide doped with 1 to 30 atom %, preferably with 2 to 10 atom % of aluminium, or with 2 to 30 atom % of indium or with 2 to 30 atom % of gallium is particularly suitable.

There are no particular restrictions regarding the amount of organic infrared absorber contained in the composition. It has proved to be particularly advantageous if the composition contains organic infrared absorber in an amount of 0.0001 wt. % to 10 wt. %, particularly 0.001 wt. % to 0.05 wt. %. Mixtures of infrared absorbers are also particularly suitable. The skilled person may optimize the absorption in the near infrared range with dyes of different wavelengths of the absorption maxima.

The composition according to the invention may contain ultraviolet absorbers as a further constituent. Ultraviolet absorbers suitable for use in the composition according to the invention include compounds having the least possible transmission below 400 nm and the highest possible transmission above 400 nm. Such compounds and the preparation thereof are known in the literature and described, for example, in EP-A 0 839 623, WO-A 96/15102 and EP-A 0 500 496. Ultraviolet absorbers which are particularly suitable for use in the composition according to the invention include benzotriazoles, triazines, benzophenones and/or arylated cyanoacrylates.

Particularly suitable ultraviolet absorbers include hydroxy benzotriazoles such as 2-(3′,5′-bis-(1,1-dimethylbenzyl)-2′-hydroxyphenyl)benzotriazole (Tinuvin® 234, Ciba Specialty Chemicals, Basle), 2-(2′-hydroxy-5′-(tert.-octyl)-phenyl)-benzotriazole (Tinuvin® 329, Ciba Specialty Chemicals, Basle), 2-(2′-hydroxy-3′-(2-butyl)-5′-tert.-butyl)-phenyl)-benzotriazole (Tinuvin® 350, Ciba Specialty Chemicals, Basle), bis-(3-(2H-benzotriazolyl)-2-hydroxy-5-tert.-octyl)methane, (Tinuvin® 360, Ciba Specialty Chemicals Basle), 2-(hydroxy-2-hydroxyphenyl)4,6-diphenyl-1,3,5-triazine (Tinuvin® 1577, Ciba Specialty Chemicals, Basle), and the benzophenone 2,4-dihydroxy-benzophenone (Chimasorb22®, Ciba Specialty Chemicals, Basle), 2-hydroxy-4-(octyloxy)-benzophenon (Chimassorb 81, Ciba, Basel), 2-propenoic acid, 2-cyano-3,3-diphenyl-, 2,2-bis[[2-cyano-1-oxo-3,3-diphenyl-2-propenyl)oxy]methyl]-1,3-propanediyl ester (9CI) (Uvinul® 3030, BASF AG Ludwigshafen). Mixtures of these ultraviolet absorbers may also be used.

There are no particular restrictions regarding the amount of ultraviolet absorber contained in the composition, provided that the desired absorption of UV radiation and sufficient transparency of the molded article manufactured from the composition are attained. According to a preferred embodiment of the invention, the composition contains ultraviolet absorber in an amount of 0.05 wt. % to 20 wt. %, particularly 0.2 wt. % to 10 wt. %.

Transparent thermoplastics within the meaning of the invention include, e.g., polymers of ethylenically unsaturated monomers and/or polycondensates of bifunctional reactive compounds. Examples of transparent thermoplastic polymers include, e.g., polycarbonates or copolycarbonates based on diphenols, poly- or copolyacrylates and poly- or copolymethacrylate such as, e.g., poly- or copolymethyl methacrylates and copolymers with styrene such as, e.g., transparent polystyrene acrylonitrile (PSAN) or polymers based on ethylene and/or propylene and aromatic polyesters such as PET, PEN or PETG and transparent thermoplastic polyurethanes. Moreover, polymers based on cyclic olefins (e.g., TOPAS®, a commercial product of Ticona), poly- or copolycondensates of terephthalic acid such as, e.g., poly- or copolyethylene terephthalates (PET or COPET) or PETG may also be incorporated.

Mixtures of several transparent thermoplastic polymers are also suitable.

Polycarbonates or copolycarbonates are preferred.

Particularly preferred polycarbonates include the homopolycarbonate based on bisphenol A, the homopolycarbonate based on 1,3-bis-(4-hydroxyphenyl)-3,3,5-trimethyl cyclohexane and the copolycarbonates based on the two monomers bisphenol A and 1,1-bis-(4-hydroxyphenyl)-3,3,5-trimethylcyclohexane.

Polycarbonates within the meaning of the present invention include both homopolycarbonates and copolycarbonates; the polycarbonates may be linear or branched conventionally.

The polycarbonates are prepared by known methods from diphenols, carbonic acid derivatives, optionally chain terminators and branching agents.

Details about the preparation of polycarbonates have been disclosed in many patents for the past 40 years or so. Reference is made here by way of example only to Schnell, “Chemistry and Physics of Polycarbonates”, Polymer Reviews, Volume 9, Interscience Publishers, New York, London, Sydney, 1964, and D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718, and finally to Dres. U. Grigo, K. Kirchner and P. R. Müller, “Polycarbonates” in Becker/Braun, Kunststoff-Handbuch, Vol. 3/1, Polycarbonates, Polyacetals, Polyesters, Cellulose Esters, Carl Hanser Verlag, Munich, Vienna 1992, pages 117-299.

Examples of diphenols suitable for the preparation of polycarbonates include hydroquinone, resorcinol, dihydroxydiphenyls, bis-(hydroxyphenyl)-alkanes, bis(hydroxyphenyl)-cycloalkanes, bis-(hydroxyphenyl)-sulfides, bis-(hydroxyphenyl)-ethers, bis-(hydroxyphenyl)-ketones, bis-(hydroxyphenyl)-sulfones, bis-(hydroxyphenyl)-sulfoxides, α,α′-bis-(hydroxyphenyl)-diisopropylbenzenes, and the compounds thereof alkylated and halogenated on the nucleus.

Preferred diphenols include 4,4′-dihydroxydiphenyl, 2,2-bis-(4-hydroxyphenyl)-propane, 2,4-bis-(4-hydroxyphenyl)-2-methylbutane, 1,1-bis-(4-hydroxyphenyl)-p-diisopropylbenzene, 2,2-bis-(3-methyl-4-hydroxyphenyl)-propane, 2,2-bis-(3-chloro-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfone, 2,4-bis-(3,5-dimethyl-4-hydroxyphenyl)-2-methylbutane, 1,1-bis-(3,5-dimethyl-4-hydroxyphenyl)-p-diisopropylbenzene, 2,2-bis-(3,5-dichloro-4-hydroxyphenyl)-propane, 2,2-bis-(3,5-dibromo-4-hydroxyphenyl)-propane and 1,1-bis-(4-hydroxyphenyl)-3,3,5-trimethylcyclohexane.

Particularly preferred diphenols include 2,2-bis-(4-hydroxyphenyl)-propane, 2,2-bis-(3,5-dimethyl-4-hydroxyphenyl)-propane, 2,2-bis-(3,5-dichloro-4-hydroxyphenyl)-propane, 2,2-bis-(3,5-dibromo-4-hydroxyphenyl)-propane, 1,1-bis-(4-hydroxyphenyl)-cyclohexane, and 1,1-bis-(4-hydroxyphenyl)-3,3,5-trimethylcyclohexane.

These and other suitable diphenols are described, e.g., in U.S. Pat. Nos. 3,028,635, 2,999,825, 3,148,172, 2,991,273, 3,271,367, 4,982,014 and 2,999,846, in DE-A 1 570 703, DE-A 2063 050, DE-A 2 036 052, DE-A 2 211 956 and DE-A 3 832 396, in FR-A 1 561 518, in the monograph “H. Schnell, Chemistry and Physics of Polycarbonates, Interscience Publishers, New York 1964”, and in JP-A 62039/1986, JP-A 62040/1986 and JP-A 105550/1986.

In the case of homopolycarbonates, only one diphenol is used; in the case of copolycarbonates, several diphenols are used.

Suitable carbonic acid derivatives include, for example, phosgene or diphenyl carbonate.

Suitable chain terminators which may be used in the preparation of the polycarbonates include both monophenols and monocarboxylic acids. Suitable monophenols include phenol itself, alkyl phenols such as cresols, p-tert.-butylphenol, p-n-octylphenol, p-iso-octylphenol, p-n-nonylphenol, and p-iso-nonylphenol, halogenated phenols such as p-chlorophenol, 2,4-dichlorophenol, p-bromophenol and 2,4,6-tribromophenol, 2,4,6-triiodophenol, p-iodophenol, and mixtures thereof.

Preferred chain terminators are phenol and/or p-tert.-butylphenol.

Suitable monocarboxylic acids also include benzoic acid, alkylbenzoic acids and halogenated benzoic acids.

Preferred chain terminators also include phenols corresponding to the formula (I)

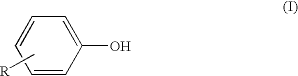

wherein

R is hydrogen or a C₁ to C₃₀ alkyl radical, linear or branched, is preferably tert.-butyl or is a branched or unbranched C₈ and/or C₉ alkyl radical.

The amount of chain terminator to be used is preferably 0.1 mole % to 5 mole %, based on moles of diphenols used in each case. The chain terminators may be added before, during or after phosgenation.

Suitable branching agents include the trifunctional or more than trifunctional compounds known in polycarbonate chemistry, particularly those having three or more than three phenolic OH groups.

Suitable branching agents include, for example, phoroglucinol, 4,6-dimethyl-2,4,6-tri-(4-hydroxyphenyl)-hept-2-ene, 4,6-dimethyl-2,4,6-tri(4-hydroxyphenyl)-heptane, 1,3,5-tri(4-hydroxyphenyl)-benzene, 1,1,1-tri-(4-hydroxyphenyl)-ethane, tri-(4-hydroxyphenyl)-phenylmethane, 2,2-bis-[4,4-bis-(4-hydroxyphenyl)-cyclohexyl]-propane, 2,4-bis-(4-hydroxyphenylisopropyl)-phenol, 2,6-bis(2-hydroxy-5′-methyl-benzyl)-4-methylphenol, 2-(4-hydroxyphenyl)-2-(2,4-dihydroxyphenyl)-propane, hexa-(4(4-hydroxyphenylisopropyl)-phenyl)-orthoterephthalic acid ester, tetra-(4-hydroxyphenyl)-methane, tetra-(4-(4-hydroxyphenylisopropyl)-phenoxy)-methane and 1,4-bis-((4′,4″-dihydroxytriphenyl)-methyl)-benzene and 2,4-dihydroxybenzoic acid, trimesic acid, cyanuric chloride and 3,3-bis-(3-methyl-4-hydroxyphenyl)-2-oxo-2,3-dihydroindol.

The amount of branching agents optionally to be used is preferably 0.05 mole % to 2 mole %, again based on moles of diphenols used in each case.

The branching agents may be charged either with the diphenols and the chain terminators in the aqueous alkaline phase, or dissolved in an organic solvent and added before phosgenation. In the case of the transesterification process, the branching agents are used together with the diphenols.

The compositions according to the invention may also contain conventional polymer additives, such as, e.g., the antioxidants and mold release agents described in EP-A 0 839 623, WO-A 96/15102 and EP-A 0 500 496, and also flame retardants, glass fibres, fillers, foaming agents, pigments, optical brighteners or dyes known in the literature, in the amounts conventionally used for the thermoplastics in question. Amounts of up to 5 wt. % in each case, preferably 0.01 wt. % to 5 wt. %, based on the amount of the compositions, are preferred, particularly preferably 0.01 wt. % to 1 wt. %, based on the amount of the compositions. Mixtures of several additives are also suitable.

The ion contents present as an impurity in the thermoplastic polycarbonates are preferably less than 10 ppm, particularly preferably less than 5 ppm.

The means for and the preparation of the thermoplastic polycarbonates are known to the skilled person.

The thermoplastic resin of the composition according to the invention may also contain conventional mold release agents. Particularly suitable mold release agents include pentaerythritol tetrastearate (PETS) or glycerol monostearate (GMS).

The preparation of the compositions according to the invention is well known and may be carried out, for example, by mixing the constituents of the composition by means of an extruder and melting the transparent thermoplastic resin during mixing.

The organic infrared absorbers, phosphine compounds, ultraviolet absorbers and other additives of the composition according to the invention may be incorporated by known methods such as compounding, incorporation in solution, coextrusion, kneading, incorporation during injection molding, or as a masterbatch.

The compositions according to the invention are suitable for the manufacture of products or molded articles, particularly for the manufacture of transparent plastic glazing elements such as, e.g., plastic glazing elements based on polycarbonate and/or copolycarbonate. The invention also provides, therefore, products or molded articles which contain or are composed of the composition according to the invention.

The compositions according to the invention may be converted by conventional methods such as hot pressing, spinning, extrusion or injection molding to products or molded articles, i.e., formed articles such as toy parts, fibres, films, film tape, sheets, multi-walled sheets, vessels, pipes or other profiles. The use of multilayer systems is also of interest. Application may take place at the same time as or immediately after the basic article has been formed, e.g., by coextrusion or multi-component injection molding. Application may also, however, take place onto the ready-formed basic article, e.g., by lamination with a film or by coating with a solution.

The compositions according to the invention may be processed to products or molded articles, for example, by extruding the compositions to granules and processing these granules in a known manner, optionally after adding the above-mentioned additives, by injection molding or extrusion to various products or molded articles.

Products or molded articles preferred according to the invention include sheets, films, glazing, for example, automobile windows, automotive sun roofs, roofing or building glazing, which contain the compositions according to the invention. Apart from the compositions according to the invention, the products according to the invention may contain, as further components, for example, further material parts. Glazing, for example, may have sealing materials at the edge of the glazing. Roofing, for example, may have metal components such as screws or the like, which may be used to fix the roofing elements.

The compositions according to the invention may be used universally as transparent products whenever heat transmission is undesirable. The use for automotive components is particularly suitable, such as, e.g., glazing elements, automotive sun roofs, plastic headlight lenses, architectural applications such as building glazing, greenhouse components, bus shelters or similar applications. Twin-wall sheets or multi-wall sheets may also be used. Moreover, the use for injection molded parts such as food containers, components of electrical appliances and in spectacle lenses, e.g., for goggles such as welding goggles, is also possible.

### EXAMPLES

The invention is described in more detail below on the basis of embodiments.

### Example 1

In order to prepare the specimens, additive-free polycarbonates Makrolon® 2808 (linear bisphenol A polycarbonate from Bayer AG, Leverkusen, with a melt flow index (MFR) of 10 g/10 min at 300° C. with a 1.2 kg load) and Makrolon® 2408 (linear bisphenol A polycarbonate from Bayer AG, Leverkusen, with a melt flow index (MFR) of 20 g/l 0 min at 300° C. with a 1.2 kg load) were compounded in a twin-shaft extruder with the amount of additive given in Table 1 and then granulated. Colored test specimens were then injected from these granules (60 mm×40 mm×2 mm).

The IR absorber used was bis(4-dimethylaminodithiobenzil) nickel (BDN) from Acros Organics, Fisher Scientific GmbH, 58239 Schwerte, Germany.

The following compounds were used as heat stabilizers:

T1: Triphenyl phosphine (Sigma-Aldrich, 82018 Taufkirchen, Germany)

T2: Octadecyl-3-(3′,5′-di-tert-butyl-4′-hydroxyphenyl)-propionate (Irganox® 1076 from Ciba Specialty Chemicals Basle, Switzerland)

T3: Tris(2,4-di-tert.-butylphenyl)-phosphite (Irgafos® 168 from Ciba Specialty Chemicals, Basle, Switzerland).

T4: Tinuvin 765 (bis(1,2,2,6,6-pentamethyl-4-piperidyl)decane dioate) (Ciba Specialty Chemicals, Basle, Switzerland).

TABLE I
Composition of the samples

| Composition | | | | | |
|---|---|---|---|---|---|
| (wt. %) | 1 | V2 | V3 | V4 | V5 |
| Polycarbonate | 90.0000 | 90.0000 | 90.0000 | 99.6930 | 90.0000 |
| (Makrolon ® 2808) | | | | | |
| Polycarbonate | 9.8925 | 9.6925 | 9.6925 | — | 9.9925 |
| (Makrolon ® 2408) | | | | | |
| IR absorber | 0.0075 | 0.0075 | 0.0075 | 0.0075 | 0.0075 |
| Heat stabilizer T1 | 0.1000 | | | | |
| Heat stabilizer T2 | | 0.3000 | | | |
| Heat stabilizer T3 | | | 0.3000 | | |
| Heat stabilizer T4 | | | | 0.3000 | |

### Example 2

The Yellowness Index (YI) of the colored test specimens made of compositions 1, V2, V3, V4 and V5 was measured before and after hot storage at 130° C. for 1000 h in accordance with ASTM E313. The percentage change in the Y.l. after hot storage for 1000 h at 130° C. was calculated from the measured values. The results are shown in Table 2.

TABLE 2
Change in the Yellowness Indices (YI) after hot storage

| | ΔYI after 1000h |
|---|---|
| Sample | hot storage at 130° C. [%] |
| 1 | 2.8 |
| V2 | 15 |
| V3 | 14.3 |
| V4 | 30.8 |
| V5 | 17.9 |

Sample 1 produced from the composition according to the invention, with a ΔYI of 2.8%, exhibited a markedly smaller change in the YI after 1000 h hot storage at 130° C. than the comparison samples V2 to V5. The results show that the sample produced from the composition according to the invention had good color fastness and little yellowing even after hot storage for 1000 h.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A thermoplastic molding composition comprising
(a) a transparent thermoplastic resin
(b) an organic infrared absorber and
(c) a phosphine compound.

2. The composition according to claim 1, wherein the phosphine compound is triphenyl phosphine or a derivative of triphenylphosphine.

3. The composition according to claim 1 wherein the phosphine compound is contained in an amount of 0.01 to 0.2% relative to the weight of the composition.

4. The composition according to claim 1 wherein the infrared absorber is contained in an amount of 0.001 to 0.05% relative to the weight of the composition.

5. The composition according to claim 1 wherein the resin is a (co)polycarbonate.

6. The composition according to claim 1 further containing a ultraviolet absorber.

7. The composition according to claim 6 wherein the ultraviolet absorber is a member selected from the group consisting of benzotriazoles, triazines, benzophenones and arylated cyanoacrylates.

8. The composition according to claim 6 wherein the ultraviolet absorber is present in an amount of 0.2 to 10% relative to the weight of the composition.

9. A process for the preparation of the composition of claim 1 comprising melting (a) in an extruder and mixing (b) and (c) with (a) therein.

10. A molded article comprising the composition according to claim 1.

11. A molded article comprising the composition of claim 5.

12. Glazing comprising the composition of claim 1.
